(19) United States
(12) Patent Application Publication
(10) Pub. No.: US 2013/0159917 A1
(43) Pub. Date: Jun. 20, 2013

(54) DYNAMIC USER INTERFACE BASED ON CONNECTED DEVICES

(71) Applicant: James C. Loebach, Raleigh, NC (US)

(72) Inventor: James C. Loebach, Raleigh, NC (US)

(73) Assignee: LENOVO (SINGAPORE) PTE. LTD., Singapore (SG)

(21) Appl. No.: 13/331,435

(22) Filed: Dec. 20, 2011

(51) Int. Cl. G06F 3/048

(52) U.S. Cl. 715/778

(57) ABSTRACT

Systems, methods and products for dynamically presenting user interfaces on an information handling device based on connected devices are presented herein. One aspect includes detecting one or more peripheral devices operatively coupled to an information handling device; executing a primary user interface; activating one or more secondary user interfaces responsive to detection of one or more peripheral devices; and switching between the primary user interface and the one or more secondary user interfaces. Other embodiments are described.

### BACKGROUND

Operating system and application developers generally design user interfaces for particular devices according to one or more design models. For example, user interfaces for mobile hand-held devices may be configured to enhance touch gesture operation, while personal or notebook computing devices may utilize interfaces arranged to handle point-and-click, menu-driven operation.

### BRIEF SUMMARY

In summary, one aspect provides an information handling device comprising: one or more processors; a memory storing program instructions accessible by the one or more processors; wherein, responsive to execution of the program instructions accessible to the one or more processors, the one or more processors are configured to: detect one or more peripheral devices operatively coupled to the information handling device; execute a primary user interface; activate one or more secondary user interfaces responsive to detection of one or more peripheral devices; and switch between the primary user interface and the one or more secondary user interfaces.

Another aspect provides a method comprising: detecting one or more peripheral devices operatively coupled to an information handling device; executing a primary user interface; activating one or more secondary user interfaces responsive to detection of one or more peripheral devices; and switching between the primary user interface and the one or more secondary user interfaces.

A further aspect provides a program product comprising: a storage medium having program code embodied therewith, the program code comprising: program code configured to detect one or more peripheral devices operatively coupled to an information handling device; program code configured to execute a primary user interface; program code configured to activate one or more secondary user interfaces responsive to detection of one or more peripheral devices; and program code configured to switch between the primary user interface and the one or more secondary user interfaces.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1A provides an example mobile user interface.

FIG. 1B provides an example full-scale interface.

FIG. 2 provides an example process for switching between operating system interfaces.

FIG. 3 provides an example process for switching between application interfaces.

FIG. 4 illustrates an example circuitry of an information handling device system.

FIG. 5 illustrates another example circuitry of an information handling device system.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

User interface design has evolved in parallel with advances in computing device technology. A prominent example involves user interfaces for mobile information handling devices, such as smartphones and tablet computing devices. The overwhelming majority of these devices are configured to accept touch screen or limited keyboard and pointing device input as the primary means of user interaction through one or more integrated input devices. Selectable user interface objects for these devices generally have certain characteristics as a consequence of facilitating less precise means of input, such as finger-based input, including being larger and having limited functionality. However, this restricts the amount of information available to a user, especially as compared to a user interface designed for keyboard and mouse input devices, wherein the size of the selectable items may be much smaller.

In addition, the difference in user interfaces has limited the general functionality of certain devices. For example, personal and laptop computing devices operating through user interfaces designed for mouse and keyboard input may be used for functions that require finer control, such as the creation of content. However, such devices have limited mobility. On the other hand, mobile devices, such as tablet computing devices, operating through touch screen input mechanisms may be more limited, for example, to content consumption because of their restrictive user interfaces. According to existing technology, a user must switch between devices in order to experience the benefits of both categories of devices. Switching between devices may also necessitate moving data, files, operating system and application settings, accessing and synchronizing devices with one or more data sources (e.g., cloud based storage), and network connection information between devices.

Embodiments provide for an information handling device configured to dynamically present a user interface to a user based on active input devices. An information handling device arranged according to embodiments may be configured to operate through a plurality of user interfaces, including, but not limited to, a mobile user interface, which may include a touch screen centered interface, and a full-scale interface designed for keyboard and point-and-click (e.g., mouse) devices, generally referred to herein as “point-and-click,” “high-resolution,” or “menu-driven” interfaces. Exemplary and non-restrictive information handling devices include cell phones, smartphones, tablet or slate computing devices, personal digital assistants (PDAs), notebook computers, and other ultra-mobile computing devices. As such, embodiments, inter alia, may operate to remove the barriers of using mobile information handling devices for both content creation and content consumption.

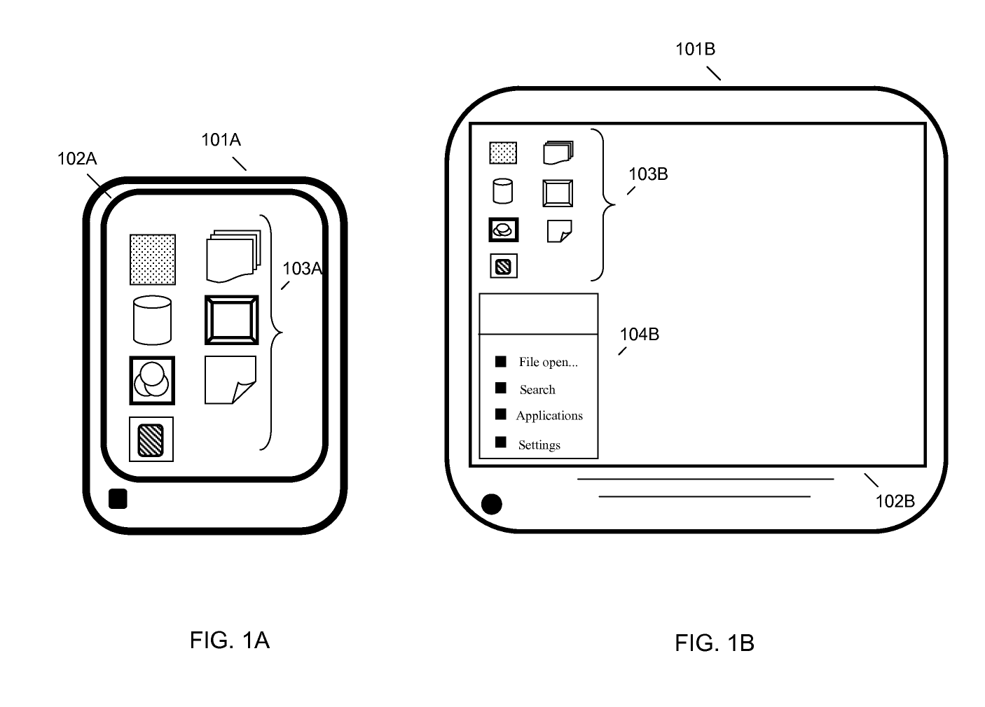

Referring to FIGS. 1A and 1B, therein is provided an example of a mobile user interface and a full-scale interface, respectively, configured according to an embodiment. In FIG. 1A, the information handling device 101A is a smartphone computing device operating through a mobile user interface 102A comprised of large icons 103A and an absence of menus, or menus with limited information (e.g., a subset of the information available in a large-scale interface). The mobile user interface 102A is conducive to operation through a touch screen or a limited keyboard and pointing device contained on the mobile device (not shown). Exemplary limited keyboards include the restrictive QWERTY keyboards provided with certain mobile devices, such as PDAs and smartphones, while exemplary limited pointing devices may include restrictive pointing and ball tracking devices also typical of PDAs and smartphones.

FIG. 1B provides an information handling device 101B in the form of a tablet computing device operating through a full-scale user interface 102B. For example, the information handling device 101B may only have an integrated touch screen input device, but may be connected to a keyboard and mouse (not shown). The full-scale user interface 102B may be comprised of smaller icons 103B and menu selection 104B elements, both of which may not be available through the mobile user interface 102A. In addition, the full-scale user interface 102B may be presented in a higher resolution as compared to the mobile user interface 102A. An information handling device configured according to embodiments may automatically switch between available user interfaces responsive to detection of one or more input devices, the absence thereof, or through one or more manual selection elements.

Embodiments are not restricted to the mobile and full-scale user interfaces provided in FIGS. 1A and 1B, as any user interfaces capable of carrying out the disclosed embodiments are contemplated herein. Non-limiting examples of user interfaces activated responsive to detection of peripheral devices include point-and-click, menu-driven, and high-resolution user interfaces. According to embodiments, a point-and-click user interface may be configured to enhance operation through a pointing device, such as a mouse. For example, the point-and-click user interface may have smaller icons and more selection menus with more information. A menu-driven user interface may present the user with more selection menus and information than a mobile user interface, with or without larger icons or higher screen resolution. The high-resolution interface may be comprised of the mobile user interface presented at a higher resolution, or it may be additionally augmented by larger icons, menus, and menu information. Embodiments provide for the user interfaces described hereinabove as well as additional user interfaces with more or less features or combinations thereof.

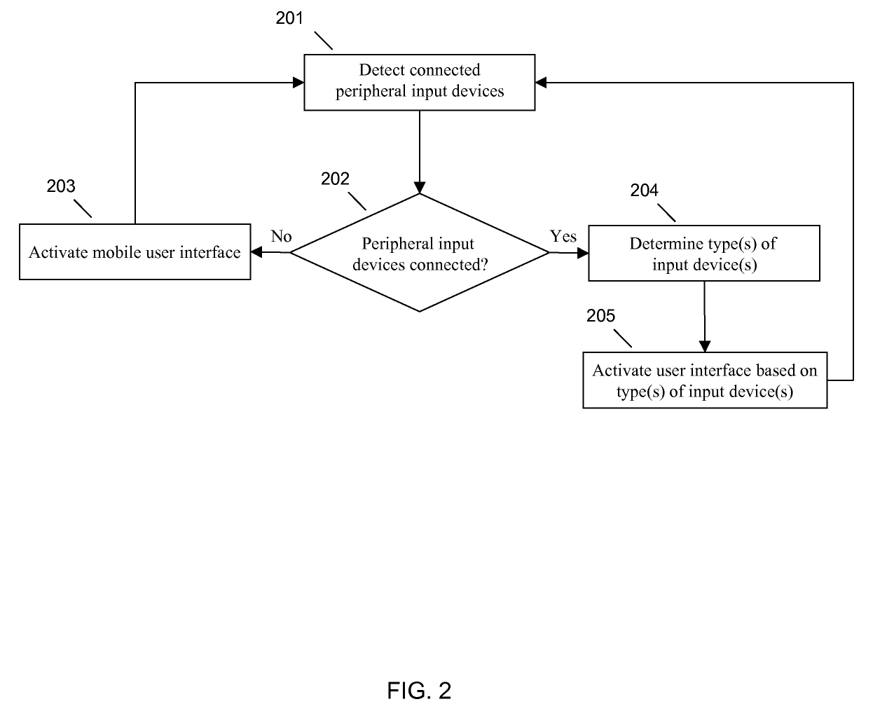

Referring to FIG. 2, therein is provided an example process for switching between interfaces on an information handling device configured according to an embodiment. An information handling device having a touch screen may determine whether peripheral devices are connected to the information handling device 201. If no peripheral devices are connected (e.g., keyboard, mouse, stylus, external monitor) 202, then the information handling device may activate the mobile user interface 203 (e.g., the default or primary user interface). If peripheral devices are detected 202, then the information handling device may determine the type(s) of input device(s) 204 and activate a corresponding user interface 205 for the type(s) of input device(s), for example, a full-scale interface (e.g., a secondary user interface).

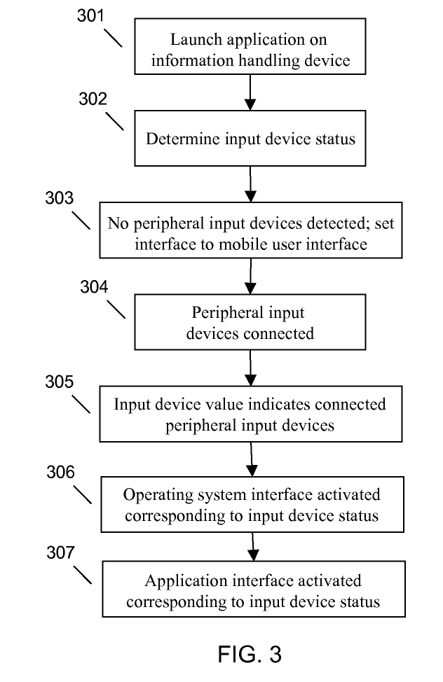

The user interface presented to a user may be comprised of an operating system interface, application interfaces, and certain menu and device settings interfaces. Accordingly, embodiments may provide for an input device status that is accessible to the operating system and to applications executing on the operating system. Referring now to FIG. 3, therein is provided an example of dynamic application user interface presentation according to an embodiment. A user may launch an application 301 on an information handling device, for example, a tablet computing device having no peripheral input devices attached, such that the device touch screen is the only input device. In this example, the application is a word processing application developed for mobile information handling devices. The word processing application determines the input device status of the tablet computing device 302, which in this example is initially set to a value indicating that no peripheral devices are attached. The word processing application activates a mobile user interface 303, which, according to certain embodiments, may be a touch screen interface. As such, the word processing application may have simplified and limited menus and word processing functions. For example, only certain frequently used functions may be presented to the user through large icons, such as a changing font size function.

The user may connect the tablet computing device to certain peripheral devices 304, for example, through a port replicator device operably coupled to mouse, keyboard, external monitor devices, or some combination thereof. The input device value may be set to a value indicating the peripheral devices attached to the tablet device 305. An operating system user interface corresponding to the input device value may be activated 306. In addition, the word processing application may detect the updated input device value and activate an interface corresponding to the current input device value 307. For example, smaller menus may now be available through the application interface, with more information, such as other document editing functions.

Current technology provides for a wide array of potential input devices. As such, embodiments may be configured to provide user interfaces based on the type or category of input device, as described in FIG. 2 at step 203, hereinabove. Non-limiting examples of input devices contemplated herein include keyboard, mouse, stylus, on-board and external touch screens, composite, joystick, and pointing stick input devices, as well as any other type of device capable of providing data and control signals to an information handling device.

One exemplary and non-restrictive example provides for a point-and-click category of devices that, when detected, may invoke a full-scale point-and-click user interface. Embodiments provide that the point-and-click user interface may have smaller icons, increased screen resolution, menus (or more menus) with more information (e.g., selection choices), as compared to a mobile user interface. Devices belonging to the point-and-click category may include mouse, pointing stick, stylus, and keyboard input devices. Another non-restrictive example may involve a high-resolution user interface, wherein smaller icons and increased screen resolution may be provided, but without enhanced menus. Devices belonging to the high-resolution interface may include a stylus and an external monitor (with or without touch screen input). The previous examples are merely representative and embodiments are not limited to mobile, point-and-click, or high-resolution interfaces, as any interface capable of carrying out embodiments provided herein is contemplated.

According to embodiments, one or more user interfaces may be configured for and associated with one or more devices or combinations thereof. For example, one type of user interface may be invoked when only a mouse is detected, another when only a keyboard is detected, and a third when both a mouse and keyboard are detected. The relationship between input devices and user interfaces may be specified by the information handling device operating system in combination with certain user preferences. Exemplary and non-limiting user preferences may allow a user to associate certain user interfaces with input devices and combinations of input devices and to modify features of available user interfaces, such as specifying the size and availability of icons, menus, and other user interface elements.

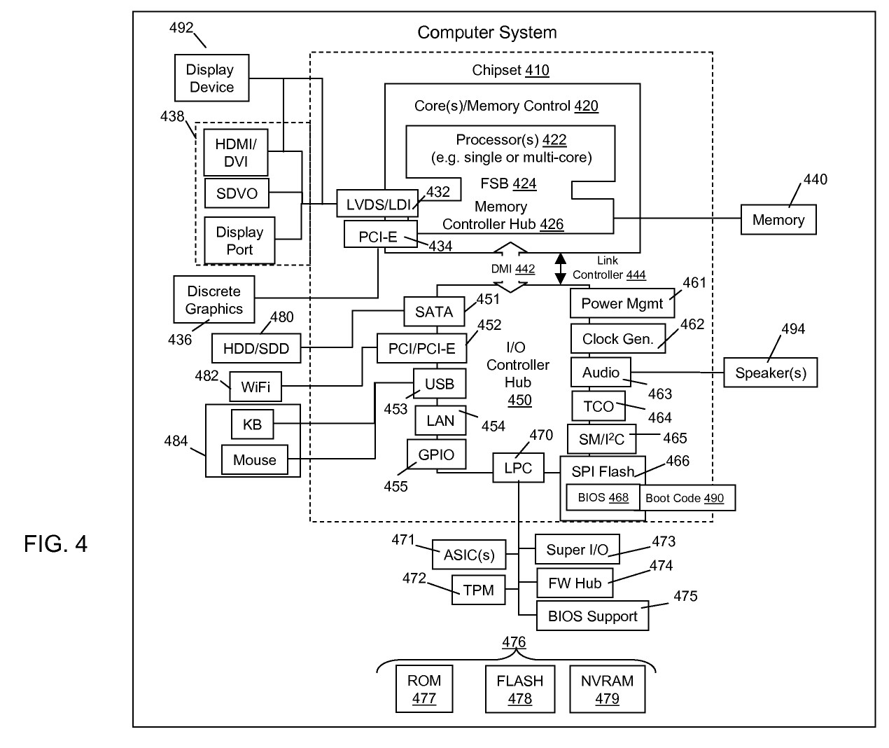

While various other circuits, circuitry or components may be utilized, FIG. 4 depicts a block diagram of one example of information handling device circuits, circuitry or components. The example depicted in FIG. 4 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 4.

The example of FIG. 4 includes a so-called chipset 410 (a group of integrated circuits, or chips, that work together, chipsets) with an architecture that may vary depending on manufacturer (for example, INTEL, AMD, ARM, etc.). The architecture of the chipset 410 includes a core and memory control group 420 and an I/O controller hub 450 that exchanges information (for example, data, signals, commands, et cetera) via a direct management interface (DMI) 442 or a link controller 444. In FIG. 4, the DMI 442 is a chip-to-chip interface (sometimes referred to as being a link between a “northbridge” and a “southbridge”). The core and memory control group 420 include one or more processors 422 (for example, single or multi-core) and a memory controller hub 426 that exchange information via a front side bus (FSB) 424; noting that components of the group 420 may be integrated in a chip that supplants the conventional “northbridge” style architecture.

In FIG. 4, the memory controller hub 426 interfaces with memory 440 (for example, to provide support for a type of RAM that may be referred to as “system memory” or “memory”). The memory controller hub 426 further includes a LVDS interface 432 for a display device 492 (for example, a CRT, a flat panel, a projector, et cetera). A block 438 includes some technologies that may be supported via the LVDS interface 432 (for example, serial digital video, HDMI/DVI, display port). The memory controller hub 426 also includes a PCI-express interface (PCI-E) 434 that may support discrete graphics 436.

In FIG. 4, the I/O hub controller 450 includes a SATA interface 451 (for example, for HDDs, SDDs, 480 et cetera), a PCI-E interface 452 (for example, for wireless connections 482), a USB interface 453 (for example, for input devices 484 such as a digitizer, keyboard, mice, cameras, phones, storage, other connected devices, et cetera), a network interface 454 (for example, LAN), a GPIO interface 455, a LPC interface 470 (for ASICs 471, a TPM 472, a super I/O 473, a firmware hub 474, BIOS support 475 as well as various types of memory 476 such as ROM 477, Flash 478, and NVRAM 479), a power management interface 461, a clock generator interface 462, an audio interface 463 (for example, for speakers 494), a TCO interface 464, a system management bus interface 465, and SPI Flash 466, which can include BIOS 468 and boot code 490. The I/O hub controller 450 may include gigabit Ethernet support.

The system, upon power on, may be configured to execute boot code 490 for the BIOS 468, as stored within the SPI Flash 466, and thereafter processes data under the control of one or more operating systems and application software (for example, stored in system memory 440). An operating system may be stored in any of a variety of locations and accessed, for example, according to instructions of the BIOS 468. As described herein, a device may include fewer or more features than shown in the system of FIG. 4.

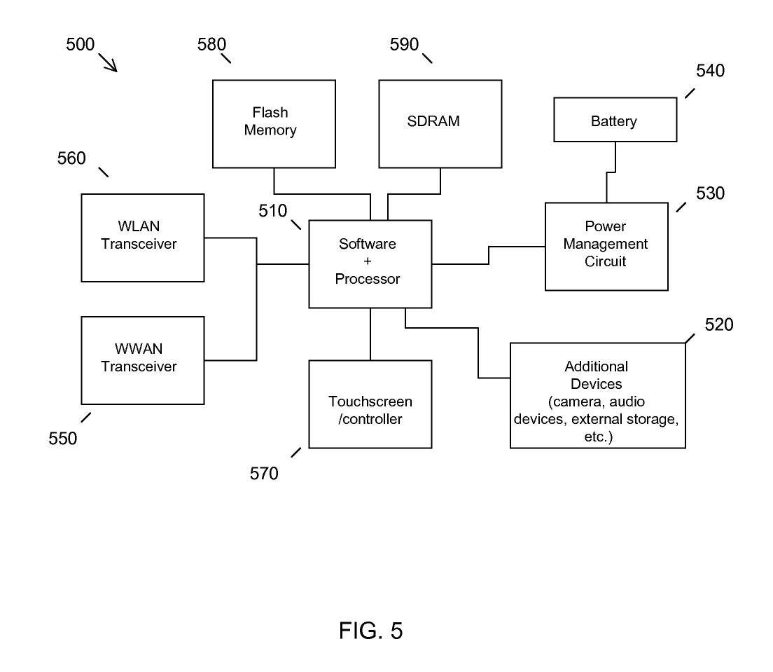

For example, referring to FIG. 5, with regard to smartphone and/or tablet circuitry 500, an example includes INTEL, AMD, and ARM based systems (systems on a chip [SoC]) design, with software and processor(s) combined in a single chip 510. Internal busses and the like depend on different vendors, but essentially all the peripheral devices (520) may attach to a single chip 510. In contrast to the circuitry illustrated in FIG. 5, the tablet circuitry 500 combines the processor, memory control, and I/O controller hub all into a single chip 510. Also, INTEL, AMD, and ARM SoC based systems 500 do not typically use SATA or PCI or LPC. Common interfaces for example include SDIO and I2C. There are power management chip(s) 530, which manage power as supplied for example via a rechargeable battery 540, which may be recharged by a connection to a power source (not shown), and in the at least one design, a single chip, such as 510, is used to supply BIOS like functionality and DRAM memory.

INTEL, AMD, and ARM SoC based systems 500 typically include one or more of a WWAN transceiver 550 and a WLAN transceiver 560 for connecting to various networks, such as telecommunications networks and wireless base stations. Commonly, an INTEL, AMD, and ARM SoC based system 500 will include a touchscreen 570 for data input and display. INTEL, AMD, and ARM SoC based systems 500 also typically include various memory devices, for example flash memory 580 and SDRAM 590.

Embodiments may be implemented in one or more information handling devices configured appropriately to execute program instructions consistent with the functionality of the embodiments as described herein. In this regard, FIGS. 4-5 illustrate non-limiting examples of such devices and components thereof. While mobile information handling devices such as tablet computers, laptop computers, and smartphones have been specifically mentioned as examples herein, embodiments may be implemented using other systems or devices as appropriate.

As will be appreciated by one skilled in the art, various aspects may be embodied as a system, method or computer (device) program product. Accordingly, aspects may take the form of an entirely hardware embodiment or an embodiment including software that may all generally be referred to herein as a “circuit,” “module” or “system.” Furthermore, aspects may take the form of a computer (device) program product embodied in one or more computer (device) readable medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection.

Aspects are described herein with reference to the figures, which illustrate example methods, devices and program products according to various example embodiments. It will be understood that the actions and functionality illustrated may be implemented at least in part by program instructions. These program instructions may be provided to a processor of a general purpose computer, special purpose computer, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the function/act specified.

The program instructions may also be loaded onto a device to cause a series of operational steps to be performed on the device to produce a device implemented process such that the instructions which execute on the device provide processes for implementing the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. An information handling device comprising:
one or more processors;
a memory storing program instructions accessible by the one or more processors;
wherein, responsive to execution of the program instructions accessible to the one or more processors, the one or more processors are configured to:
detect one or more peripheral devices operatively coupled to the information handling device;
execute a primary user interface;
activate one or more secondary user interfaces responsive to detection of one or more peripheral devices; and
switch between the primary user interface and the one or more secondary user interfaces.

2. The information handling device according to claim 1, wherein the information handling device comprises a tablet computing device.

3. The information handling device according to claim 1, wherein the primary user interface comprises a mobile user interface.

4. The information handling device according to claim 1, wherein the one or more secondary user interfaces comprise a full-scale user interface.

5. The information handling device according to claim 4, wherein the full-scale user interface comprises a point-and-click user interface.

6. The information handling device according to claim 5, wherein the one or more peripheral devices comprise a mouse input device.

7. The information handling device according to claim 4, wherein the one or more peripheral devices comprise an external display device.

8. The information handling device according to claim 7, wherein the full-scale user interface comprises a high-resolution user interface.

9. The information handling device according to claim 1, wherein the one or more secondary user interfaces are associated with one or more peripheral devices.

10. The information handling device according to claim 1, wherein the one or more processors are further configured to switch between the primary user interface and the one or more secondary user interfaces responsive to selection of a manual interface selection element.

11. A method comprising:
detecting one or more peripheral devices operatively coupled to an information handling device;
executing a primary user interface;
activating one or more secondary user interfaces responsive to detection of one or more peripheral devices; and
switching between the primary user interface and the one or more secondary user interfaces.

12. The method according to claim 11, wherein the information handling device comprises a tablet computing device.

13. The method according to claim 11, wherein the primary user interface comprises a mobile user interface.

14. The method according to claim 11, wherein the one or more secondary user interfaces comprises a full-scale user interface.

15. The method according to claim 14, wherein the full-scale user interface comprises a point-and-click user interface.

16. The method according to claim 15, wherein the one or more peripheral devices comprise a mouse input device.

17. The method according to claim 14, wherein the one or more peripheral devices comprise an external display device.

18. The method according to claim 17, wherein the full-scale user interface comprises a high-resolution user interface.

19. The method according to claim 11, wherein the one or more secondary user interfaces is associated with one or more peripheral devices.

20. A program product comprising:
a storage medium having program code embodied therewith, the program code comprising:
program code configured to detect one or more peripheral devices operatively coupled to an information handling device;
program code configured to execute a primary user interface;
program code configured to activate one or more secondary user interfaces responsive to detection of one or more peripheral devices; and
program code configured to switch between the primary user interface and the one or more secondary user interfaces.
